(19) United States
(12) Patent Application Publication
(10) Pub. No.: US 2021/0358467 A1
(43) Pub. Date: Nov. 18, 2021

(54) NOISE REDUCING COVER

(71) Applicant: Jordan Welling, Portland, OR (US)

(72) Inventor: Jordan Welling, Portland, OR (US)

(21) Appl. No.: 17/323,486

(22) Filed: May 18, 2021

Related U.S. Application Data
(60) Provisional application No. 63/026,248, filed on May 18, 2020.
(60) Provisional application No. 63/065,014, filed on Aug. 13, 2020.

(51) Int. Cl. G10K 11/168; B60N 2/60

(52) U.S. Cl. CPC G10K 11/168; B60N 2/60

(57) ABSTRACT

A noise reducing cover, such as a noise reducing baby cover, is provided. The noise reducing cover includes a body having a noise reducing portion, the noise reducing portion being made of a noise reducing fabric. In one version, the noise reducing fabric is a noise reducing composite fabric having a layer of fabric with a permeability reducing coating on a surface of the layer of fabric. The permeability, density, and thickness of the noise reducing composite fabric are selected to reduce the transmission of noise through the noise reducing portion so that the noise reducing composite fabric reduces the noise transmitted through the noise reducing portion of the noise reducing cover while remaining flexible. The noise reducing cover may be adapted to be used as a child's car seat cover, an apron, and/or a baby stroller cover. Alternatively, the noise reducing cover can be a pet cover or pet compartment cover, or the like.

### PRIORITY

The present application claims the benefit of domestic priority based on U.S. Provisional Patent Application 63/026,248 filed on May 18, 2020 and on U.S. Provisional Patent Application 63/065,014 filed on Aug. 13, 2020, the entireties of both of which are incorporated herein by reference.

### BACKGROUND

Babies bring much joy into the world and into the lives of parents and caregivers.

They also bring concern, both in terms of noise they generate and in terms of the noise and other environmental factors that a baby is exposed to. The same can be said for pets.

Few aspects of parenthood and childcare generate as much angst as a crying baby. Not only does a crying baby make a parent worry about the baby and the cause of the crying, it also can be distracting for a parent who is trying to work, focus on a task, or relax, especially when the crying is persistent. In addition, a parent may be concerned and conscientious about the crying when the baby is in public. On airplanes or public transportation this can be particularly worrisome. Conversely, outside noise can be problematic for babies. Outside or unexpected noise can keep a baby from falling asleep or can awaken a baby that has already fallen asleep. An awake baby may be bothered or agitated by noise which can often incite the creation of more noise by causing the baby to start crying.

Heretofore there has not been an effective product designed to reduce the noise coming from and/or going to a baby. Prior attempts to address the problem have included the use of ear plugs or noise cancelling headphones. However, ear plugs and headphones are not desirable because they block the hearing of the wearer which can be hazardous or an annoyance. Also, ear plugs and headphones only block sound for one user and do not help a crowd of people. Existing acoustic blankets are also not ideal for use with a baby. The acoustic blanket can be suffocation hazard for a baby. In addition, there is no convenient way to easily and safely use the acoustic blankets in and around the baby.

The reduction of noise in other environments can also be desirable. For example, a pet can be a source of undesirable noise. This is particularly true for pets that are contained within a pet compartments, such as a pet carrier, kennel, and/or crate. In addition, the reduction of noise within the pet compartment can have a calming effect on the pet in the compartment and can help the pet sleep.

There is therefore a need for a way to provide improved noise reduction. There is further a need to reduce the noise generated by a crying baby and/or being delivered to a baby. There is further a need for an improved baby cover that reduces the noise to and/or from a baby. There is still further a need for a noise reducing baby cover that can be worn by a parent or caregiver. There is still further a need for a noise reducing baby cover that is adapted to at least partially enclose a baby's car seat, around a baby stroller, and/or the like. There is still further a need for a noise reducing baby cover that can both be worn by a parent or caregiver and that can be hung from a baby's car seat, around a baby stroller and/or the like. There is still further a need for a noise reducing baby cover that has additional features, such as reduction of light transmission, blocking of heat and UV rays from the sun, and/or the like. There is a further need for a noise reducing cover for a pet. There is a further need for a noise reducing cover for use with a pet compartment.

### SUMMARY

The present invention satisfies these needs. In one aspect of the invention, an improved noise reduction cover is provided.

In another aspect of the invention, a child's car seat cover provides improved noise reduction.

In another aspect of the invention, a nursing apron for a child's caregiver provides improved noise reduction.

In another aspect of the invention, a baby stroller cover provides improved noise reduction.

In another aspect of the invention, a combination child's car seat cover, nursing apron, and/or baby stroller cover provides improved noise reduction.

In another aspect of the invention, a cover for a pet compartment provides improved noise reduction.

In another aspect of the invention, a cover reduces light transmission and/or UV ray transmission.

In another aspect of the invention, a noise reducing cover also reduces light transmission and/or UV ray transmission.

In another aspect of the invention, a noise reducing cover comprises a noise reducing portion comprising a noise reducing fabric.

In another aspect of the invention, a noise reducing cover comprises a noise reducing portion comprising a noise reducing fabric.

In another aspect of the invention, a noise reducing cover comprises a noise reducing portion comprising a noise reducing composite fabric that offers noise reduction while maintaining flexibility.

In another aspect of the invention, a noise reducing cover comprises a noise reducing portion comprising a noise reducing composite fabric that is sufficiently impermeable to provide noise reduction.

In another aspect of the invention, a noise reducing cover comprises a noise reducing portion comprising a noise reducing composite fabric that is sufficiently dense to provide noise reduction.

In another aspect of the invention, a noise reducing cover comprises a noise reducing portion comprising a noise reducing composite fabric that is sufficiently thick to provide noise reduction.

In another aspect of the invention, a noise reducing cover comprises a noise reducing portion comprising a noise reducing composite fabric that is sufficiently impermeable and/or dense to provide noise reduction while being sufficiently thin to maintain flexibility.

In another aspect of the invention, a noise reducing cover comprises a body having a noise reducing portion, the noise reducing portion being made of a noise reducing fabric, wherein the permeability, density, and thickness of the noise reducing fabric are selected to reduce the transmission of noise through the noise reducing portion, and wherein the noise reducing composite fabric reduces the noise transmitted through the noise reducing portion of the noise reducing cover while remaining flexible.

In another aspect of the invention, a noise reducing cover comprises a body having a noise reducing portion, the noise reducing portion being made of a noise reducing composite fabric, the noise reducing composite fabric comprising a layer of fabric having a permeability reducing coating on a surface of the layer of fabric, wherein the permeability, density, and thickness of the noise reducing composite fabric are selected to reduce the transmission of noise through the noise reducing portion, and wherein the noise reducing composite fabric reduces the noise transmitted through the noise reducing portion of the noise reducing cover while remaining flexible.

In another aspect of the invention, a noise reducing cover comprises a body having a noise reducing portion, the noise reducing portion being made of a noise reducing composite fabric, the noise reducing composite fabric comprising a layer of fabric having a permeability reducing coating on a surface of the layer of fabric, wherein the permeability, density, and thickness of the noise reducing composite fabric are selected to reduce the transmission of noise through the noise reducing portion, and wherein the noise reducing composite fabric reduces the noise transmitted through the noise reducing portion of the noise reducing cover while remaining flexible, wherein the noise reducing composite fabric is sufficiently impermeable, dense, and thick to reduce a 60 decibel noise in the human audible frequency range by at least about 12 decibels.

In another aspect of the invention, a noise reducing cover comprises a body having a noise reducing portion, the noise reducing portion being made of a noise reducing composite fabric, the noise reducing composite fabric comprising a layer of fabric having a permeability reducing coating on a surface of the layer of fabric, wherein the permeability, density, and thickness of the noise reducing composite fabric are selected to reduce the transmission of noise through the noise reducing portion, and wherein the noise reducing composite fabric reduces the noise transmitted through the noise reducing portion of the noise reducing cover while remaining flexible, wherein the permeability reducing coating comprises an acrylic foam sprayed onto a surface of the layer of fabric.

In another aspect of the invention, a noise reducing cover comprises a body having a noise reducing portion, the noise reducing portion being made of a noise reducing composite fabric, the noise reducing composite fabric comprising a layer of fabric having a permeability reducing coating on a surface of the layer of fabric, wherein the permeability, density, and thickness of the noise reducing composite fabric are selected to reduce the transmission of noise through the noise reducing portion, and wherein the noise reducing composite fabric reduces the noise transmitted through the noise reducing portion of the noise reducing cover while remaining flexible, wherein the noise reducing composite fabric has a density across its thickness of at least about 0.02 g/cm².

In another aspect of the invention, a noise reducing car seat cover for a child's car seat comprises a body having a draping portion sized and shape to at least partially enclose a car seat, the body including a noise reducing portion, and an attachment mechanism adapted to attach the body to the handle of the car seat, wherein the noise reducing portion is made of a noise reducing composite fabric, and wherein the noise reducing composite fabric is sufficiently impermeable, dense, and thick to reduce a 60 decibel noise in the human audible frequency range by at least about 12 decibels.

In another aspect of the invention, a noise reducing apron, such as a nursing apron, comprises a body having a draping portion sized and shape to at least partially enclose a baby being held by a user, the body including a noise reducing portion, and a support mechanism adapted to support the draping portion from the user's neck or shoulders, wherein the noise reducing portion is made of a noise reducing composite fabric, and wherein the noise reducing composite fabric is sufficiently impermeable, dense, and thick to reduce a 60 decibel noise in the human audible frequency range by at least about 12 decibels.

In another aspect of the invention, a noise reducing baby stroller cover comprises a body having a draping portion sized and shape to at least partially cover a baby stroller, the body including a noise reducing portion, wherein the noise reducing portion is made of a noise reducing composite fabric, and wherein the noise reducing composite fabric is sufficiently impermeable, dense, and thick to reduce a 60 decibel noise in the human audible frequency range by at least about 12 decibels.

In another aspect of the invention, a noise reducing baby cover comprises a combination car seat cover for a child's car seat and apron, the cover comprising a body having a draping portion sized and shape to selectively at least partially enclose a car seat or to at least partially enclose a baby being held by a user, the body including a noise reducing portion, an attachment mechanism adapted to attach the body to the handle of the car seat, and a support mechanism adapted to support the draping portion from the user's neck or shoulders, wherein the noise reducing portion is made of a noise reducing composite fabric, and wherein the noise reducing composite fabric is sufficiently impermeable, dense, and thick to reduce a 60 decibel noise in the human audible frequency range by at least about 12 decibels.

In another aspect of the invention, a noise reducing baby cover comprises a combination car seat cover for a child's car seat and baby stroller cover, the cover comprising a body having a draping portion sized and shape to selectively at least partially enclose a car seat or to cover a baby stroller, the body including a noise reducing portion, and an attachment mechanism adapted to attach the body to the handle of the car seat, wherein the noise reducing portion is made of a noise reducing composite fabric, and wherein the noise reducing composite fabric is sufficiently impermeable, dense, and thick to reduce a 60 decibel noise in the human audible frequency range by at least about 12 decibels.

In another aspect of the invention, a noise reducing baby cover comprises a combination car seat cover for a child's car seat, apron, and/or baby stroller cover, the cover comprising a body having a draping portion sized and shape to selectively at least partially enclose a car seat, to at least partially enclose a baby being held by a user, and/or to at least partially cover a baby stroller the body including a noise reducing portion, an attachment mechanism adapted to attach the body to the handle of the car seat, and/or a support mechanism adapted to support the draping portion from the user's neck or shoulders, wherein the noise reducing portion is made of a noise reducing composite fabric, and wherein the noise reducing composite fabric is sufficiently impermeable, dense, and thick to reduce a 60 decibel noise in the human audible frequency range by at least about 12 decibels.

In another aspect of the invention, a method of reducing noise coming from and being exposed to a baby in a child's car seat comprises providing a body having a draping portion adapted to at least partially enclose a child's car seat, the body including a noise reducing portion; draping the draping portion around the car seat while a baby is sitting in the car seat; and securing the body to the car seat; wherein the noise reducing portion is sufficiently impermeable, dense, and thick to reduce a 60 decibel noise in the human audible frequency range by at least about 12 decibels.

In another aspect of the invention, a method of reducing noise coming from and being exposed to a baby in a child's car seat comprises providing a body having a draping portion adapted to at least partially enclose a child's car seat, the body including a noise reducing portion; draping the draping portion around the car seat while a baby is sitting in the car seat; securing the body to the car seat; removing the body from the car seat; draping the draping portion as an apron around a baby being held by a user; and securing the draping portion to the user's neck or shoulders, wherein the noise reducing portion is sufficiently impermeable, dense, and thick to reduce a 60 decibel noise in the human audible frequency range by at least about 12 decibels.

In another aspect of the invention, a method of reducing noise coming from and being exposed to a baby in a child's car seat comprises providing a body having a draping portion adapted to at least partially enclose a child's car seat, the body including a noise reducing portion; draping the draping portion around the car seat while a baby is sitting in the car seat; securing the body to the car seat; removing the body from the car seat; and draping the draping portion over a baby stroller, wherein the noise reducing portion is sufficiently impermeable, dense, and thick to reduce a 60 decibel noise in the human audible frequency range by at least about 12 decibels.

In another aspect of the invention, a noise reducing cover includes a combination of any of the above-mentioned aspects and/or any other feature discussed herein.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic front view of a version of a noise reducing cover according to the invention;

FIG. 1B is a schematic sectional side view of the noise reducing cover of FIG. 1A;

FIG. 1C is a perspective view of the noise reducing cover of FIG. 1A with the interior exposed;

FIG. 1D is a schematic sectional side view of another version of a noise reducing cover;

FIG. 1E is a perspective view of a version of the noise reducing cover of FIG. 1D;

FIG. 2A is a schematic front view of another version of a noise reducing cover of the invention;

FIG. 2B is a perspective view of the noise reducing cover of FIG. 2A in use;

FIG. 3A is a schematic front view of another version of a noise reducing cover of the invention;

FIG. 3B is a perspective view of the noise reducing cover of FIG. 3A in use;

FIG. 4 is a schematic front view of another version of a noise reducing cover of the invention;

FIG. 5 is a schematic front view of another version of a noise reducing cover of the invention;

FIG. 6A is a perspective view of another version of a noise reducing cover in the form of a noise reducing stroller cover;

FIG. 6B is a perspective view of the noise reducing stroller cover of FIG. 6A in use;

FIG. 7A is a perspective view of another version of a noise reducing cover in the form of a noise reducing pet cover;

FIG. 7B is a perspective view of another version of a noise reducing pet cover; and

FIG. 7C is a perspective view of another version of a noise reducing pet cover.

### DESCRIPTION

The present invention relates to the reduction of noise coming from and/or being delivered to an object. In particular, the invention relates to a noise reducing cover. Although the noise reducing cover is illustrated and described in the context of being useful for babies and/or for pets, the present invention can be useful in other instances. Accordingly, the present invention is not intended to be limited to the examples and embodiments described herein.

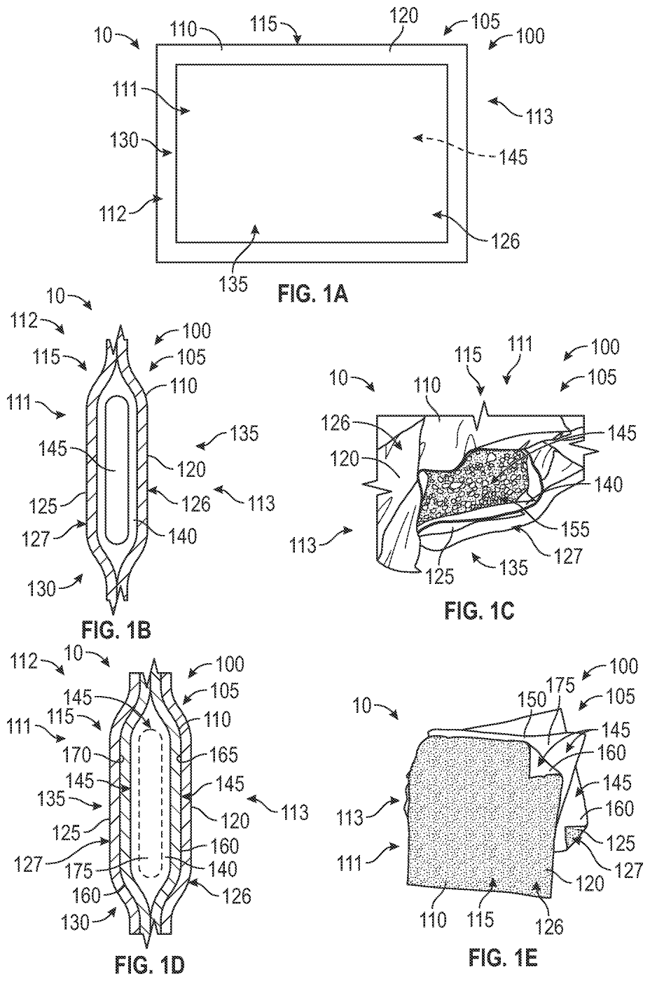

FIG. 1A shows a noise reducing cover 10, such as a noise reducing baby cover 100, according to a version of the invention. By cover it is meant any solid object that can be used to cover or block at least a portion of a baby or other animate or inanimate object and/or otherwise serve as a barrier of any sort, whether or not the cover is actually covering a baby. By baby cover it is meant a cover that is sized and shaped to be used in association with a baby whether or not the cover is actually covering or contacting a baby. In the version shown, the noise reducing cover 10 is a baby cover 100 having a body 105 that in the version shown is generally flat and sheet-like. The body 105 can be in any desired shape and can take any desired form, such as the forms embodied herein. In the version shown in FIG. 1A, the body 105 is generally rectangular. Alternatively, the body 105 can be square, triangular, polygonal, rounded, circular, oval, ovoid, or the like. The body 105 has an outer surface 110 made of a material suitable to come into contact with a baby or other user of the noise reducing baby cover 100.

The body 105 of the cover 10 includes a noise reducing portion 111 that makes up at least a portion of the body 105 and preferably a major portion of the body 105. The body 105 may also include one or more non-noise reducing portions 112, such as shown in FIG. 1A around the periphery or elsewhere on the body 105. Alternatively, the entirety of the body 105 can be noise reducing. By noise reducing it is meant that when noise is transmitted through the noise reducing portion there is a noticeable and/or detectable reduction in the amount of noise. For example, there may be a noticeable muffling of the sound and/or may be a detectable reduction in the volume or decibel level. In one version, the noise reducing portion 111 is sufficient to reduce a 60 decibel noise in the human audible frequency range by at least about 12 decibels. In another version, the noise reducing portion 111 is sufficient to reduce a 60 decibel noise in the human audible frequency range by at least about 15 decibels. In another version, the noise reducing portion 111 is sufficient to reduce a 60 decibel noise in the human audible frequency range by at least about 18 decibels. In one particular version, the noise reducing portion 111 is sufficient to reduce a 60 decibel noise in the human audible frequency range by about 20 decibels. This 20 decibel reduction results in about a 75% reduction in the perceived volume by a human.

In one version, at least a portion of the noise reducing portion 111 is a noise reducing composite fabric 113. By noise reducing composite it is meant that noise reducing body comprises a combination of materials and/or a material that has been treated in a manner so as to create the noise reducing properties, as described above. By fabric, it is meant that the material behaves in a fabric-like and/or cloth-like manner in that it is thin, flexible, moldable, shapeable, and/or conformable as a sheet or a piece of fabric. The noise reducing composite fabric 112 may be formable into a variety of shapes and configurations, as will be described.

An example of a noise reducing composite fabric 113 is shown in FIGS. 1B and 1C. In this version, the body 105 includes an outer covering 115 made of a first layer 120, such as a top layer of material, and a second layer 125, such as a bottom layer of material. The outer surface 110 of the cover 10 is made up of an outer surface 126 of the first layer of material 120 and an outer surface 127 of the second layer of material 125. The first layer of material 120 and the second layer of material 125 may be connected to one another around a periphery 130 of the body 105, such as by sewing, adhesive, or the like. Alternatively, the first layer of material 120 and the second layer of material 125 may be a single continuous piece. In a central portion 135, the first layer of material 120 and the second layer of material 125 are separated from one another so as to form an interior space 140 between the first layer of material 120 and the second layer of material 125, as can be seen in FIG. 1B.

Within the interior space 140 noise reducing material 145 may be provided. By noise reducing material it is meant a material that reduces the transmission of sound therethrough when compared with a different material of the same size and shape. Noise reducing materials are typically of decreased permeability, of higher density or packing, and/or of increased thickness than conventional materials as will be explained in more detail. Noise reducing materials made from cotton or polyester fibers may be treated, dimensioned, and/or packed in a manner that the noise transmission is less than if the material was not treated, dimensioned, and/or packed. For example, the noise reducing material 145 may comprise one or more of treated or untreated cotton, polyester, or cotton/polyester blend, polyurethane, needle punched cotton batting, mineral wool, stone wool, glass wool, foam, fiberglass, cellulose insulation, recycled paper product, recycled denim, mass loaded vinyl or silicone, or the like. In one version, the noise reducing material 145 comprises foam, such as acrylic foam. Alternatively or additionally, the noise reducing material 145 comprises a polyester, such as a triple weave polyester that is made up of a top fabric layer, a bottom fabric layer, and a high density yarn layer between the two fabric layers. Alternatively or additionally, the noise reducing material 145 comprises one or more, and preferably a plurality, of layers of needle-punched cotton batting, which has a lower loft or airiness than untreated cotton. The noise reducing material 145 can be in a solid sheet 150 form, as shown in FIG. 1B, or can be loose material 155 that is packed into the interior space 140, as shown in FIG. 1C which shows the outer covering 115 opened to expose the interior space 140 and the noise reducing material 145. In one version, the noise reducing material 145 is sufficiently thick or dense to provide at least a noticeable reduction in noise. In one version, the noise reducing material 145 comprises a material that has greater noise-reducing properties than the material of the outer covering 115 without the noise reducing material 145. In another version, the noise reducing material 145 is part of or incorporated into the first layer 120 and/or second layer 125 of the outer covering. In this version, there may be additional noise reducing material 145 in the interior space 140, there may be no additional material in the interior space 140, or the interior space may be closed by the first layer 120 and the second layer 125 contacting one another.

The outer covering 115 can be made of any suitable material. In one version, the outer covering 115 is made of a material that is sufficiently strong to contain the noise reducing material 145 in the interior space 140. In one version, the outer covering 115 may also be made of material that allows the noise reducing cover 10 to be flexible and/or moldable. For example, the outer covering 115 may be made of one or more of polyester, cotton, polyester/cotton blend, laminate, a spray-on protective coating, Gore-Tex, acrylic foam, and the like, and in one particular version comprises polyester. In addition, in one version, at least the surface 110 of the outer covering 115 is made of a material that is safe and comfortable to come in contact what a baby's skin. In one version, the outer covering 115 is made of a water resistant or water repellant material. The first layer of material 120 and the second layer of material 125 may be made of the same or different material.

Another version of a noise reducing composite fabric 113 for a noise reducing cover 10 is shown in FIGS. 1D and 1E. In this version, the noise reducing material 145 is in the form of a lining 160 or layer of material near or on an inner surface 165 of the first layer 120 and/or near or on an inner surface 170 of the second layer 125. The noise reducing material 145 may optionally further comprise additional noise reducing material 175 within the interior space 140. Alternatively, the noise reducing material 145 consists only of the first layer 120 and the second layer 125 and the lining 160 on one or both of the first layer 120 and the second layer 125. In one particular version, the lining 160 comprises a permeability reducing coating. The permeability reducing coating has a permeability of water or other liquid that is less than the material or fabric of the first layer 120 or when applied to the first layer 120 the combination of the first layer 120 and the permeability reducing coating 160 result in a coated fabric that have a permeability less than the uncoated fabric. In one version, the permeability reducing coating 160 is a foam material, such as a thin layer of acrylic or polyurethane foam that is applied to the inner surface 165 of the first layer 120 and/or the inner surface 170 of the second layer 125, such as by being sprayed on. In one version, the lining 160 is from about 0.5 mils to 0.5 inches thick, or from about 1.0 mils to about 0.25 inches thick, or from about 2.0 mils to about 0.1 inches thick. In one version, the noise reducing composite fabric 113 comprises a single layer, such as first layer 120, that is coated with the permeability reducing coating 160 to a sufficient extent that the combination results is noise reduction.

The first layer 120 and/or second layer 125 to which the lining 160 is attached may be a fabric or other material. For example, the first layer 120 and/or second layer 125 may comprise a material that allows the noise reducing baby cover to be flexible and/or moldable. For example, the first layer 120 and/or second layer 125 may comprise one or more of polyester, cotton, polyester/cotton blend, laminate, a spray-on protective coating, Gore-Tex, and the like, and in one particular version comprises polyester. In addition, in one version, at least the surface 110 of the outer covering 115 or the outer surface 126 of the first layer 120 and/or the outer surface 127 second layer 125 is made of a material that is safe and comfortable to come in contact what a baby's skin. In one version, the outer covering 115 is made of a water resistant or water repellant material. The first layer of material 120 and the second layer of material 125 may be made of the same or different material. When used, the additional noise reducing material 175 can comprise any of the above mentioned noise reducing materials in either solid sheet form or as loose material. In one particular version, the additional noise reducing material 175 comprises triple weave polyester which includes high density yarn.

The noise reducing composite fabric 112 of FIGS. 1D and 1E takes advantage of a combination of factors that combine to provide a superior noise reduction effect. One factor is the use of a level of impermeability of the material. A material that has reduced permeability has been determined to have higher noise reduction than a higher permeability material. An impermeable material is one in which water or other liquid does not easily pass through under normal conditions. It has been discovered that impermeable materials tend to have higher sound reduction properties than relatively more permeable materials. Accordingly, in one version, the noise reducing composite fabric 112 is sufficiently impermeable to resist a pressure of at least about 1000 ml of water without leaking. A second factor that contributes to noise reduction is density, such as its area density or mass per unit area. Denser materials will achieve greater noise reduction than less dense materials for a given thickness. Accordingly, in one version, the noise reducing composite fabric 112 has a total density across its thickness of at least about 0.02 g/cm², or at least about 0.04 g/cm², or at least about 0.08 g/cm², and in one particular version has a total density across its thickness of about 0.085 g/cm². A third factor is thickness. The thicker the material, the greater the noise reduction. Of course, it is also desirable to minimize thickness to reduce bulk and increase flexibility of the cover 10. Accordingly, in one version, the noise reducing composite fabric 112 has a thickness of from about 0.05 inches to about 0.5 inches. In the case of a noise reduction cover 10 that is in the form of a baby cover 100, it can also be desirable for the noise reduction composite fabric 113 to be sufficiently flexible that the cover can be used in a variety of manners as the baby cover. By flexible it is meant that the cover 10 would be able to be draped over an object, such as a child's car seat, so that it at least partially adapts to the form of the object. By flexible it may also or alternatively be meant that the cover 10 is able to be folded and retain its position in the folded position.

To achieve a desire level of noise reduction, the noise reducing composite fabric 113 can include a combination of the above three factors. For example, for a given permeability, the density and/or thickness can be adjusted so that the achieved noise level is at a desired level. In another example, for a given density, the permeability and/or thickness can be selected so that the noise reduction is at a desired level. In another example, for a given thickness, the permeability and/or density can be selected so that the noise reduction is at a desired level. This latter example can be important when the thickness of the noise reducing composite fabric 113 needs to be sufficiently thin to maintain the flexibility of the fabric. For example, in one version, the noise reducing composite fabric 113 is less than 0.2 inches thick, or less than 0.1 inches thick. In this version, the permeability and the density of the noise reducing composite fabric can be selected so that the noise reducing composite fabric is sufficient to reduce a 60 decibel noise in the human audible frequency range by at least about 12 decibels, or by at least about 15 decibels, or by at least about 18 decibels, or by about 20 decibels.

In one particular version, the noise reducing composite fabric 112 incorporates all three of the above-mentioned factors. In this particular version, the noise reducing composite fabric 113 includes an impermeability coating, such as an acrylic foam coating 160, that is applied to the inner surface 165 of the first layer 120 and/or the inner surface 170 of the second layer 125 of a fabric to make it impermeable. The foam coating 160 that is sprayed onto the inner surface 165 of the first layer 120 and/or the inner surface 170 of the second layer 125 of a fabric adds another benefit in that the resulting impermeable material remains flexible so that the cover can be adapted in shape into a desired form. The noise reducing composite fabric 113 can further include an additional noise reducing material 145 in the interior space 140. In one version, the additional noise reducing material 145 comprises a triple weave polyester/yarn fabric whereby higher density and tightly woven polyester and yarn add density. Thickness is created by having three layers of material that are stitched together. The combination of materials also serves to filter out different frequencies of sound.

One version of a noise reducing cover 10 include a noise reducing composite fabric 113 as shown in FIGS. 1D and 1E has been tested to achieve a reduction of 20 decibels or approximately 75% reduction in perceived volume at its noise reducing portion 111. The test was performed in a manner to measure maximum sound reduction by isolating the materials as the only pathway for sound to travel through when recorded with the decibel measuring device. Specifically, the test was performed by placing a speaker inside of a bowl made from borosilicate glass (i.e. pyrex) with the speaker producing a constant sound of an airhorn at 1000 Hz frequency and at a volume level that is received by the external sound measuring device at a level of 60 decibels. By placing materials over the borosilicate glass bowl and completely covering the pathway of sound, a measure of 40 decibels or reduction in 20 decibels was recorded. This or an equivalent test can be used to ascertain the noise reduction qualities discussed herein.

Together the outer covering 115 and the noise reducing material 145 form the noise reducing composite fabric 113 that can be used to form a noise reducing cover 10 that serves as a barrier to noise. The noise reducing cover 10 when used as a noise reducing baby cover 100 can be positioned between a baby, such as a baby that is crying or that is likely to start crying, and another person so that the noise from the baby that reaches the person is a significant reduction in noise compared to the noise that would reach the person in the absence of the noise reduction baby cover 100. In addition, the noise reducing baby cover 100 can be positioned between a source of noise and a baby so that the noise from the source that reaches the baby is a significant reduction in noise compared to the noise that would reach the baby in the absence of the noise reduction baby cover 100.

In use the noise reducing cover 100 can be used to cover at least a portion of the baby in a manner that at least partially blocks the transmission of noise to and/or from the baby. In one version, the noise reducing baby cover 100 can be at least partially wrapped around the baby. Alternatively or additionally, the noise reducing baby cover 100 can be hung or otherwise held in a position where it establishes a wall or barrier that is spaced from the baby.

In one version, the outer covering 115 can be made of a material that also serves to block the transmission of light. By reducing the amount of light that penetrates the noise reducing cover 100, an environment can be created around that baby that is more soothing and womblike and that can help to calm the baby so the baby can sleep and/or cry less. In this version, the outer covering 115 can comprises one or more light reducing materials, such as one or more of velvet, polyester, cotton, high density black yarn, and the like. In one particular version, the outer covering 115 comprises polyester with a foam coated backing. In this version, the material and/or arrangement of the material is effective in reducing by at least 95% the light transmission, more preferably at least 99%, and most preferably at least 99.9%, as measured by a standard lux meter, such as an ennoLogic Light Meter eL200K. In one version, the noise-reducing material can be removed, and the cover can be made of the light-reducing material without the noise-reducing features. In another version, the outer covering comprises a triple weave polyester with the foam coating.

In one version, the outer covering 115 can be made of a material that also serves to provide heat block and temperature insulation properties. By reducing the amount of heat that can pass through the cover 10. This version is particularly useful when the cover 10 is used as a baby cover 100. The baby cover 100 prevents a baby beneath the baby cover from overheating, especially when in the sun. In this version, the material and/or arrangement of the material is effective in reducing heat transmission due to rays of sunlight by at least about 50%, more preferably at least about 60% over a cover that lacks the noise reducing portion 111.

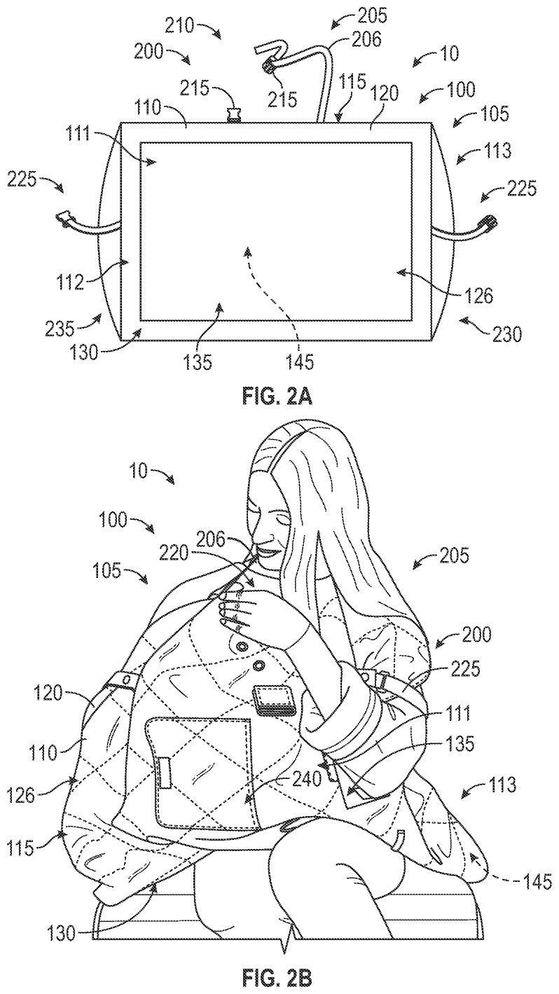

A version of a noise reducing cover 10 in the form of a noise reducing baby cover 100 is shown in FIGS. 2A and 2B. In this version, the noise reducing baby cover 100 is adapted to be worn by a parent or other caregiver. For example, in the particular version shown, the noise reducing baby cover 100 has a body 105 that has a draping portion in the form of an apron 200, such as a nursing apron, which can be worn around a caregiver's neck so that the noise reducing baby cover 100 can be draped around a baby that is being held by the caregiver. A supporting mechanism 205 such as a neck strap 206 can be provided to secure the apron 200 around the caregiver's neck or around the caregiver's shoulders. Optionally, a fastening mechanism 210 can be provided, such as the clips 215 shown, buttons, snaps, or the like, to facilitate the donning of the apron 200. Alternatively, the neck strap 206 can be sufficiently long and/or elastic to slide over the head of the wearer. In one version, as shown in FIG. 2B, the neck strap 206 can be designed and positioned so that when the apron 200 is worn, a sufficiently large gap 220 is created below the neck that allows the baby being held to be seen by the caregiver. This allows the caregiver to be able to see and make eye contact with the baby which can help to lessen the baby's crying. Optionally, one or more side straps 225 may be provided on the left side 230 and/or right side 235 of the apron 200 to allow the apron to be fastened around the back of the wearer. This can help to further reduce the noise escaping the apron. In one version, the side straps 225 are adjustable so that the snugness of the apron can be adjusted. The side straps 225 can include hardware, such as clips, or may be straps that tie onto loops or onto one another.

In another version, the straps may be detachable. Additional optional features, such as a pocket 240 or the like, can also be provided on the outer covering 115.

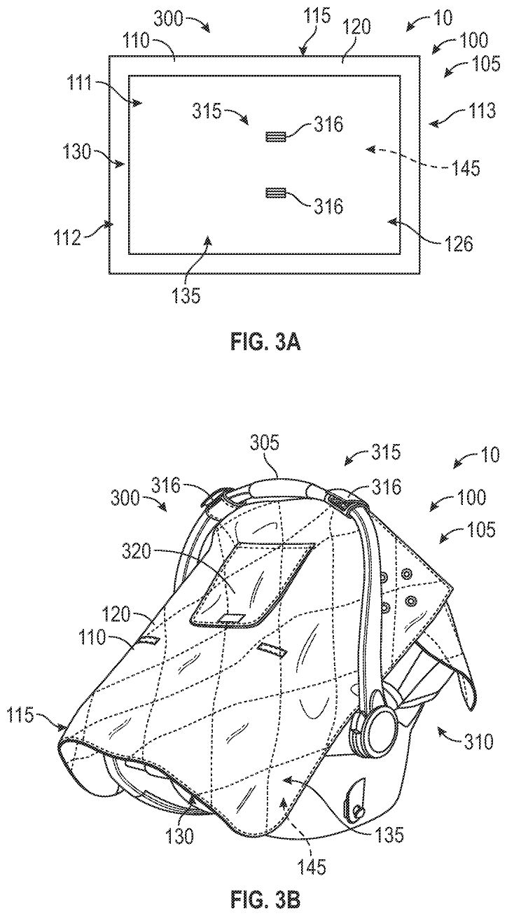

Another version of a noise reducing cover 100 is shown in FIGS. 3A and 3B. In this version, the noise reducing cover 100 has a body 105 having a draping portion in the form of a child's car seat cover 300 that can be used to at drape over a handle 305 of a child's car seat 100 and to at least partially enclose the child's car seat 310. The car seat cover 300 can be connected to the child's car seat 310 such as by including a hanging mechanism 315 that connects to the handle 310 or from another object. For example, the hanging mechanism 315 can comprise one or more hanging straps 316 that can be provided in the central portion 135 of the body 105 to facilitate the hanging of the car seat cover 300. For example, the hanging straps 316 can comprise hook and loop type of fasteners to allow for easy installation. Alternatively, any other type of fastener can be provided. In the version shown, the hanging straps 316 are provided on the top surface of the outer covering 115. Alternatively, the hanging straps can be on the bottom surface so the entire car seat cover 300 can be draped over the handle 305. Optionally, an opening, such as a slit or the like, or a window feature 320, such as a transparent material coverable by a flap, can be provided to make it easier to see the baby in the car seat 310.

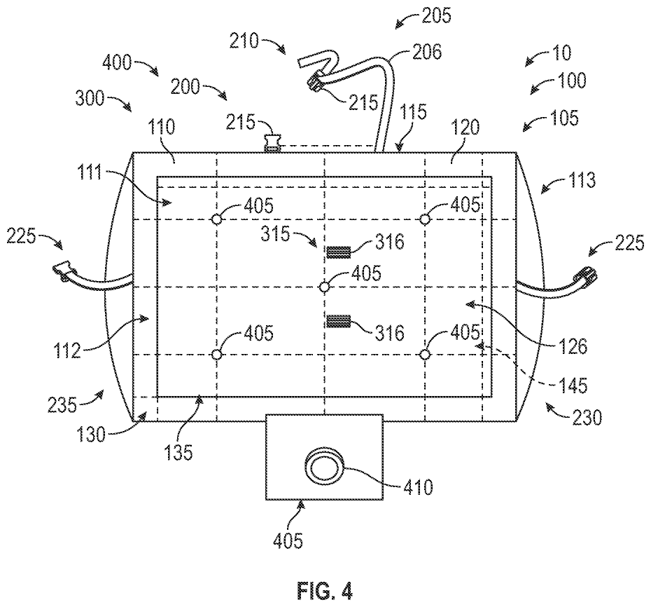

Another version of a noise reducing cover 10 in the form of a noise reducing baby cover 100 is shown in FIG. 4. In this version, the noise reducing baby cover 100 is a combination cover 400 and can be used as either an apron 200 or a car seat cover 300 that can be hung from a car seat handle or the like. As also shown in FIG. 4, one or more openings 405 can be provided that extend through the noise reducing baby cover 100 to allow air to pass through to allow breathability through the cover and ensure that the baby is provided with sufficient air flow. In the version shown, five such openings 405 are provided. However, any suitable number may be provided, such as 2, 2 or more, 3 or more, 4 or more, or 5 or more. The openings 405 can be in the form of a sewn grommet 410 or can be in any other form.

FIG. 4 also shows exemplary dimensions for a version of the noise reducing baby cover 100. For a body 105 of the noise reducing cover 100 having a top length and a side length, the top length can range from about 20 inches to about 100 inches, or from about 30 inches to about 60 inches, or from about 40 inches to about 50 inches. The left side and/or right side can range from about 15 inches to about 80 inches, or from about 20 inches to about 50 inches, or from about 30 inches to about 40 inches. The periphery 130 can range from about 0 inches to about 15 inches, or from about 0.2 inches to about 7 inches, or from about 0.5 inches to about 5 inches. In one version, the periphery 130 is about 0 inches. The thickness of the noise reduction cover 100 can range from about 0.02 inches to about 1.5 inches, from about 0.2 inches to about 1.5 inches, or from about 0.3 inches to about 1 inch, or from about 0.4 inches to about 0.6 inches. In one particular version using sufficiently impermeable and dense materials, the thickness can range from about 0.02 inches to about 0.2 inches, or from about 0.05 inches to about 0.09 inches, and in one version is about 0.06 inches. The openings 405 or grommets 400 can have a diameter or equivalent cross-sectional dimension of from about 0 inches to 0.6 inches, or from about 0.03 inches to about 0.5 inches.

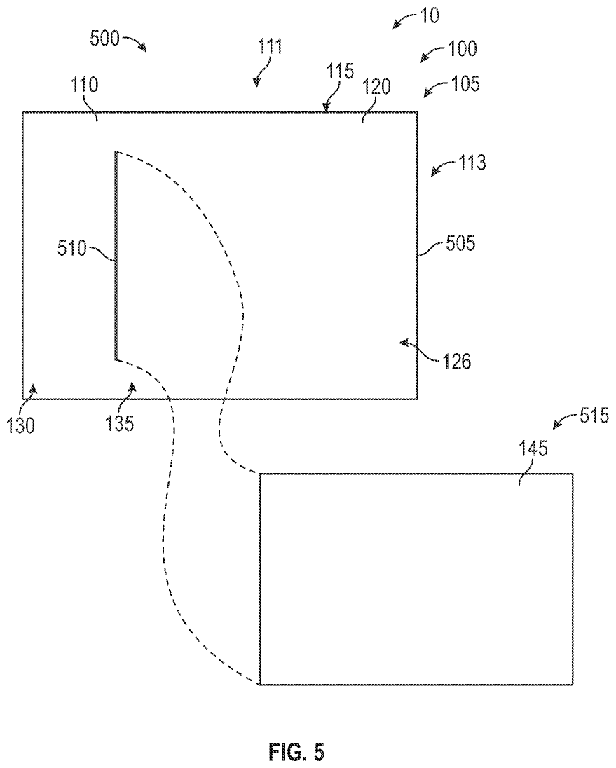

Another version of the noise reducing cover 10 in the form of a noise reducing baby cover 100 is shown in FIG. 5. In this version, the noise reducing baby cover 100 is a modular system 500 where the outer covering 115 is a shell 505 having a slit 510 that provides access to the interior space 140. The noise reducing material 145 is in the form of a pad 515 that can be removably inserted into the interior space 140 through the slit 510. In this version, the outer covering 115 can be separated from the noise reducing material 145 so that it can be cleaned or replaced.

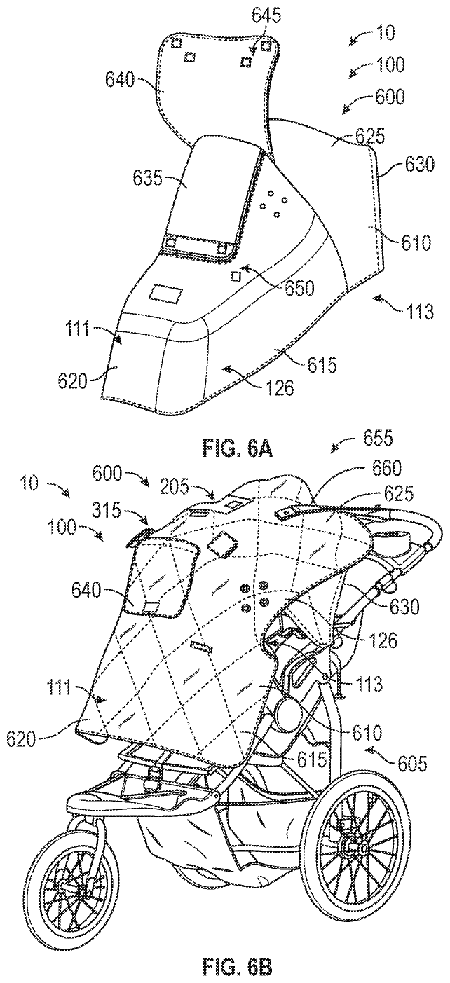

Another version of the noise reducing cover 10 in the form of a noise reducing baby cover 100 is shown in FIG. 6A. In this version, the noise reducing baby cover 100 has a body 105 that includes a draping portion that can serve as a baby stroller cover 600. FIG. 6B shows the baby stroller cover 600 installed on a baby stroller 605 with the draping portion of the body 105 draped over at least a portion of the baby stroller 605. The baby stroller cover 600 has a body 610 comprising one or more portions or its entirety made of the noise reducing composite fabric 113. For example, in the version shown, the baby stroller cover 600 includes a pair of side portions 615, a front portion 620, and a rear portion 625, one or more of which can be made of the noise reducing composite fabric 113. The rear portion 625 can include an attachment mechanism 630, such as Velcro or the like, to help secure the baby stroller cover 600 to the baby stroller 605. Optionally, the front portion 620 can include a transparent window portion 635 made of a material other than the noise reducing composite fabric 112. A flap portion 640 that is made of noise reducing composite fabric 112 can be provided to selectively cover the window portion 635. The flap portion 640 can be provided with a fastener 645 that cooperates with a fastener 650 on the body 610 to maintain the flap portion 640 in a covering position. The fasteners 645, 650 can be Velcro, snaps, buttons, or the like. A securing system 655 with one or more stroller straps 660 can optionally be provided to help secure the baby stroller cover 600 onto the baby stroller 605, such as by being fastenable around the handle of the baby stroller 605.

In one particular version, as shown in FIG. 6B, the noise reducing baby cover 100 is a three way system that includes all of the features of the apron 200, the car seat cover 300, and/or the baby stroller cover 600. In this version, the body 105 is sized and shaped to serve as each of the apron 200, the car seat cover 300, and the baby stroller cover 600. In addition, the cover 10 may also include each of the supporting mechanism 205, such as a neck strap 206 on the long side of the body 105 or elsewhere on the body 105, for supporting the apron 200 around the neck or shoulders of a user, the hanging mechanism 315, such as the hanging straps 316, for hanging the car seat cover 300 from the handle of a child's car seat, and a securing mechanism 655, such as the stroller strap or straps 660 on a short side of the body 105 or elsewhere on the body 105. In another version, the noise reducing baby cover 100 is a two way system with any combination of two of the apron 200, the car seat cover 300, and the baby stroller cover 600.

Various other feature or designs for the noise reducing cover 10 can additionally or alternatively be provided. For example, the noise reducing cover 10 can be made of a material that also blocks light and/or that provides heat insulation. The outer covering 115 can be quilted or not quilted and/or can included printed designs, images, or indicia. The noise reducing cover 10 can be in the form of a sling or can include an integrated sling under the apron version.

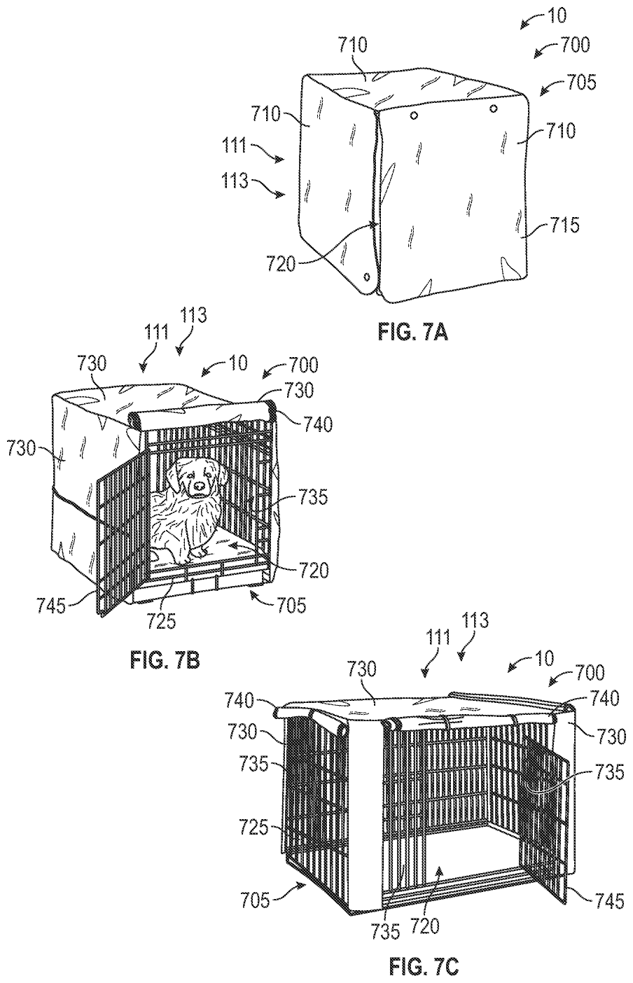

FIG. 7A illustrates another version of a noise reducing cover 10 according to the invention. In this version, the noise reducing cover 10 is in the form of a pet cover 700. The noise reducing cover in this version can be used to cover or block at least a portion of a pet or other animate or inanimate object and/or otherwise serve as a barrier of any sort, whether or not the cover is actually covering a pet. By pet cover it is meant a cover that is sized and shaped to be used in association with a pet or other animal whether or not the cover is actually covering or contacting a pet or other animal. The noise reducing pet cover 700 can be used to cover a pet directly or indirectly. For example, in the version of FIG. 7A, the noise reducing pet cover 700 is sized and shaped to be a cover for a pet compartment 705. By pet compartment it is meant any structure that is designed, dimensioned, and/or shaped to contain a pet therein. Examples of pet compartments 705 include pet crates, such as a dog or cat crate, a pet carrier, such as a dog or cat carrier, and/or a kennel or cage. The pet compartment 705 can be a free-standing structure, as shown in FIG. 8A with walls 710 comprising the noise reducing cover 10. The walls 710 can be supported or unsupported. In the version of FIG. 7A, one of the walls 710 is in the form of a flap 715 that can be lifted so that a pet can enter into an interior 720 of the pet compartment 705.

Alternatively, as shown in FIG. 7B, the noise reducing pet cover 700 can be a cover that covers an existing pet compartment 705, such as the pet crate 725. In this version, the noise reducing pet cover 700 has one or more panels 730 that are sized and shaped to corresponding fittingly with the existing pet compartment 705. For example, as shown, the one or more panels 730 can be approximately the same size and shape as one or more sidewalls 735 of the pet compartment 705. A front panel 740 can be flippable, foldable, rollable, or the like, so that a door 745 of the pet compartment 705 can be accessed. Optionally, as shown in FIG. 7C, additional other panels 730 can also be flippable, foldable, rollable, or the like so that the panel 730 selectively covers or uncovers a sidewall 735 of the pet compartment 705.

The noise reducing pet cover 700 can be selectively placed on, around, or near a pet to reduce the noise coming from the pet and/or being heard by the pet. For example, when used in proximity to a barking dog, the noise reducing cover with reduce the sound of the barking so that the barking is less annoying to those in proximity to the pet and/or can reduce the distance at which the barking sounds are detectable. In addition, the noise reducing pet cover 700 can reduce the noise that is presented to the pet. Thus, as easily agitated pet is less likely to hear sounds that can disturb the pet, and a sleeping pet is less likely to be awakened by a noise.

The noise reducing pet cover 700 can optionally be provided with additional features. For example, the noise reducing pet cover 700 can include a closure system whereby one or more panels 730 can be secured in a covering position. For example, a closure system cab comprise a strap extending from a panel 730. The strap can have a snap or the like that snaps onto another panel 730 or other portion of the noise reducing pet cover 700. In one version, a hook and loop fastener or a zipper can be attached the panel 730.

The noise reducing pet cover 700 can be constructed in accordance with any of the above embodiments disclosed in connection with the noise reducing baby cover 100. For example, one or more of the panels 730 can be made of a noise reducing composite fabric, such as one or more of an acrylic foam backed fabric, a triple weave high density yarn, and a mass loaded vinyl. In one version, one or more mass loaded vinyl inserts are positionable within a pocket within one or more of the panels 730 of the noise reducing pet cover 700. For example, a handle exposing feature can be provided that includes a flap that is positionable in an open position to expose a handle of the pet compartment. The flap can have a fastener system, such as a hook and loop fastening system, that secures the flap in one or more of an open and closed position. In another version, the flap can be in the form of a rollable piece of material. The exposing feature can be made of noise reducing material or may be absent noise reducing material. In one version, the noise reducing pet cover can be provided with an optional vent in one or more of the panels 730. For example, a panel 730 can have a side flap that makes up only a portion of a panel 730. The side flap can be selectively opened to allow air to enter the pet compartment 705 and/or to allow for interaction with a pet within the pet compartment 730. The side flap can also be equipped with a mechanism to maintain the side flap in one or more of the close and open positions.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” and their variations such as “consists” should be understood to imply the inclusion of a stated element, limitation, or step and not the exclusion of any other elements, limitations, or steps or any other non-essential elements, limitations, or steps, respectively. Throughout the specification, any discussed on a combination of elements, limitations, or steps should be understood to include a disclosure of additional elements, limitations, or steps and the disclosure of the exclusion of additional elements, limitations, or steps. All numerical values, unless otherwise made clear in the disclosure or prosecution, include either the exact value or approximations in the vicinity of the stated numerical values, such as for example about +/− ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A noise reducing cover comprising:
a body having a noise reducing portion, the noise reducing portion being made of a noise reducing composite fabric, the noise reducing composite fabric comprising a layer of fabric having a permeability reducing coating on a surface of the layer of fabric,
wherein the permeability, density, and thickness of the noise reducing composite fabric are selected to reduce the transmission of noise through the noise reducing portion, and wherein the noise reducing composite fabric reduces the noise transmitted through the noise reducing portion of the noise reducing cover while remaining flexible.

2. A noise reducing cover according to claim 1 wherein the noise reducing composite fabric is sufficiently impermeable, dense, and thick to reduce a 60 decibel noise in the human audible frequency range by at least about 12 decibels.

3. A noise reducing cover according to claim 1 wherein the permeability reducing coating comprises an acrylic foam sprayed onto a surface of the layer of fabric.

4. A noise reducing cover according to claim 1 wherein the noise reducing composite fabric is sufficiently impermeable to resist a pressure of at least about 1000 ml of water without leaking.

5. A noise reducing cover according to claim 1 wherein the noise reducing composite fabric is less than about 0.2 inches thick.

6. A noise reducing cover according to claim 1 wherein the noise reducing composite fabric has a density across its thickness of at least about 0.02 g/cm².

7. A noise reducing cover according to claim 1 wherein the layer of fabric is a first layer of fabric in the noise reducing composite fabric, the first layer having an outer surface and an inner surface, wherein the noise reducing composite fabric further comprises a second layer of fabric having an outer surface and an inner surface, and wherein the permeability reducing coating is applied to the inner surface of the first layer of fabric.

8. A noise reducing cover according to claim 7 wherein a permeability reducing coating is also applied to the inner surface of the second layer of fabric.

9. A noise reducing cover according to claim 7 wherein the noise reducing composite fabric comprises an additional layer of material between the first layer and the second layer.

10. A noise reducing cover according to claim 9 wherein the noise reducing composite fabric comprises an additional layer of material between the first layer and the second layer, the additional layer comprising a multi-layered weave of polyester and yarn.

11. A noise reducing cover according to claim 1 wherein the body has a draping portion sized and shape to at least partially enclose a child's car seat, the draping portion including the noise reducing portion, and wherein the noise reducing cover further comprises an attachment mechanism adapted to attach the body to the handle of the car seat.

12. A noise reducing cover according to claim 1 wherein the draping portion is also sized and shaped to be worn as an apron by a user holding a baby, the body including a supporting mechanism adapted to support the apron on the user's neck or shoulders.

13. A noise reducing cover according to claim 1 wherein the body has a draping portion sized and shaped to be worn as an apron by a user holding a baby, the body including a supporting mechanism adapted to support the apron on the user's neck or shoulders.

14. A noise reducing cover according to claim 1 wherein the body has a draping portion sized and shaped to be draped around a baby stroller and wherein the noise reducing cover includes a securing mechanism to help secure the noise reducing cover to a baby stroller.

15. A noise reducing cover according to claim 1 wherein the body is in the form of a pet cover.

16. A noise reducing car seat cover for a child's car seat, the noise reducing car seat cover comprising:
a body having a draping portion sized and shape to at least partially enclose a car seat, the body including a noise reducing portion;
an attachment mechanism adapted to attach the body to the handle of the car seat,
wherein the noise reducing portion is made of a noise reducing composite fabric, and wherein the noise reducing composite fabric is sufficiently impermeable, dense, and thick to reduce a 60 decibel noise in the human audible frequency range by at least about 12 decibels.

17. A noise reducing baby cover according to claim 16 wherein the noise reducing composite fabric comprises a first layer of material having an outer surface and an inner surface, a second layer of material having an outer surface and an inner surface, and an impermeable coating on the inner surface of the first layer, the impermeable coating comprising a foam lining the inner surface of the first layer.

18. A noise reducing baby cover according to claim 16 wherein the noise reducing composite fabric comprises a first layer of material having an outer surface and an inner surface, a second layer of material having an outer surface and an inner surface, and an impermeable coating on the inner surface of the first layer, the impermeable coating comprising a foam lining the inner surface of the first layer, and wherein the noise reducing composite fabric further comprises an additional layer of material between the first layer and the second layer, the additional layer comprising a triple weave polyester.

19. A noise reducing baby cover according to claim 16 wherein the body is adapted to also serve as an apron to at least partially surround a baby being held by a user, the apron including a support mechanism adapted to support the apron on the user's neck or shoulders.

20. A method of reducing noise coming from and being exposed to a baby in a child's car seat, the method comprising:
providing a body having a draping portion adapted to at least partially enclose a child's car seat, the body including a noise reducing portion;
draping the draping portion around the car seat while a baby is sitting in the car seat;
securing the body to the car seat;
removing the body from the car seat;
draping the draping portion as an apron around a baby being held by a user; and
securing the draping portion to the user's neck or shoulders,
wherein the noise reducing portion is sufficiently impermeable, dense, and thick to reduce a 60 decibel noise in the human audible frequency range by at least about 12 decibels.
